(19) United States
(12) Patent Application Publication
(10) Pub. No.: US 2021/0166241 A1
(43) Pub. Date: Jun. 3, 2021

(54) METHODS, APPARATUSES, STORAGE MEDIUMS AND TERMINAL DEVICES FOR AUTHENTICATION

(71) Applicant: World Concept Development Limited, Hong Kong (HK)

(72) Inventor: Wang Kee WOO, Hong Kong (HK)

(21) Appl. No.: 17/171,493

(22) Filed: Feb. 9, 2021

Related U.S. Application Data
(63) Continuation of application No. PCT/CN2019/099885, filed on Aug. 9, 2019.

(30) Foreign Application Priority Data
Aug. 14, 2018 (HK) 18110406.7

(51) Int. Cl. G06Q 20/40; G06K 9/00; G10L 17/24; H04L 9/32

(52) U.S. Cl. CPC G06Q 20/40145; G06K 9/00288; H04L 9/3231; H04L 9/3228; G10L 17/24

(57) ABSTRACT

The present invention provides methods, apparatuses, storage mediums and terminal devices for product authentication. The methods comprises: receiving an authentication request of the user; the authentication request includes a user account; responding to the verification request, and providing a random verification code to the user; wherein the random verification code is used to prompt the user to make a sound and read out the verification code; obtaining a dynamic facial picture and audio data when the user reads the random verification code; and verifying whether the identity of the user matches the identity of the user account, according to the dynamic facial picture, the audio data, and the random verification code. With the present invention, the security of authentication can be improved.

### CROSS-REFERENCE TO RELATED APPLICATIONS

This application is a continuation of International Patent Application No. PCT/CN2019/099885 with a filing date of Aug. 9, 2019, designating the United States, now pending, and further claims priority of Hong Kong Patent application 18110406.7, filed Aug. 14 2018. The content of the aforementioned applications, including any intervening amendments thereto, are incorporated herein by reference.

### TECHNICAL FIELD

The invention relates to the field of computer technology, in particular to a method, an apparatus, a storage medium and a terminal device for authentication.

### BACKGROUND

With the development of the Internet and information security, in the process of logging in to a personal account to perform a series of operations, the registrant is generally required to enter a password to log in to its corresponding personal account. However, since the password is easily stolen, the password is generally verified by face recognition or voice recognition to verify whether the registrant is the authorized person corresponding to the logged-in personal account. However, both options have their own shortcomings.

For the solution of face recognition, it has the following disadvantages:

1. Unauthorized persons can use pre-recorded data, such as photos of an authorized person, to perform face recognition and can be authorized to login.

2. In order to improve the pass rate of the face recognition of the authorized person, the threshold of matching the facial features is usually lowered, but at the same time, the risk of verification successfully by the unauthorized person is also increased. For example, when a user handles banking, the bank generally verifies that the user is a real authorized person. If the threshold for matching facial features is lowered, the banking institution is at a high risk.

3. In order to reduce the pass rate of the unauthorized person, the threshold of matching the facial features is usually increased, but at the same time, the failure rate of the face recognition for the authorized person is also increased.

For the solution of voice recognition, it has the following disadvantages:

1. Unauthorized persons can use pre-recorded data, such as the audio record of the authorized person, to perform voice recognition and can be authorized to login.

2. In most cases, the voice of the registrant needs to be transmitted to the login system through the user terminal. Generally, it is determined by binding the phone number to the identity of the authorized person whether the registrant is the authorized person. However, since the company or government agency leaks the customer data, the unauthorized person can easily know the authorized person's telephone number and can access the personal information such as the service password associated with the authorized person's telephone number. In this way, the unauthorized person can contact the operator to transfer the authorized person's phone number to the new mobile phone. This is the common “SIM card exchange”. Unauthorized persons can use the new mobile phone, the audio record of the authorized person, to be authorized to login.

### SUMMARY

It is an object of the present invention to provide a method, an apparatus, a storage medium and a terminal device for authentication to solve one or more of the technical problems set forth above in the prior art.

In a first aspect, embodiments of the present invention provide a method for authentication, comprising: receiving an authentication request of the user; the authentication request includes a user account; responding to the verification request, and providing a random verification code to the user; wherein the random verification code is used to prompt the user to make a sound and read out the verification code; obtaining a dynamic facial picture and audio data when the user reads the random verification code; and verifying whether the identity of the user matches the identity of the user account, according to the dynamic facial picture, the audio data, and the random verification code.

In a second aspect, embodiments of the present invention provide an apparatus for authentication, comprising: an authentication request receiving module, configured to receive an authentication request of the user; the authentication request includes a user account; a verification code providing module, configured to provide a random verification code to the user in response to the authentication request; wherein the random verification code is used to prompt the user to make a sound and read the verification code; a picture and audio receiving module, configured to acquire a dynamic facial picture and audio data when the user reads the random verification code; and an authentication module, configured to verify whether the identity of the user matches the identity of the user account, according to the dynamic facial picture, the audio data, and the random verification code.

The functions of the device may be implemented by hardware or by corresponding software implemented by hardware. The hardware or software includes one or more modules corresponding to the functions described above.

In one possible design, the structure of the authentication includes a processor and a memory for storing a program of the method for authentication in the above first aspect performed by the authentication device, the processor being configured to execute the program stored in the memory. The device for authentication may also include a communication interface, the device for authentication communicating with other devices or communication networks.

In a third aspect, embodiments of the present invention provide a computer readable and non-transitory storage medium, configured to computer software instructions used by an apparatus for authentication, including a program involved in a method for performing authentication in the first aspect above.

Any one of the above technical solutions has the following advantages or beneficial effects:

In the embodiment of the present invention, when verifying the identity of the user, a random verification code is provided to the user, and the user emits a sound and reads the verification code when learning the random verification code. The corresponding dynamic facial picture and audio data are obtained during the process of reading the verification code by the user, so as to prevent the unauthorized person from obtaining the authorization by using the photo of the authorized person or the audio record of the authorized person in the process of verifying the identity of the user.

The above summary is only for the purpose of illustration and is not intended to be limiting. In addition to the illustrative aspects, embodiments and features described above, further aspects, embodiments and features of the present invention will be readily apparent by reference to the drawings and detailed description below.

### BRIEF DESCRIPTION OF THE DRAWINGS

In the drawings, the same reference numerals are used to refer to the same or similar parts or elements unless otherwise stated. The drawings are not necessarily to scale. It is to be understood that the appended drawings are merely illustrative of the embodiments of the invention, and are not intended to limit the scope of the invention.

FIG. 1 is a flow chart of an embodiment of a method for authentication provided by the present invention;

FIG. 2 is a flow chart of an embodiment of a face recognition and voice recognition for identity provided by the present invention;

FIG. 3 is a flow chart of an embodiment of verifying a user's identity via a device identification code of a Bluetooth device provided by the present invention;

FIG. 4 is a flow chart of another embodiment of verifying a user's identity via a device identification code of a Bluetooth device provided by the present invention;

FIG. 5 is a schematic diagram of an application example of registration of a new user provided by the present invention;

FIG. 6 is a schematic diagram of an application example of authentication without verifying numbers of a Bluetooth device provided by the present invention;

FIG. 7 is a schematic diagram of an application example of authentication with verifying numbers of a Bluetooth device provided by the present invention;

FIG. 8 is a structural diagram of an embodiment of an apparatus for authentication provided by the present invention;

FIG. 9 is a structural diagram of an embodiment of a terminal device provided by the present invention.

### DETAILED DESCRIPTION OF THE INVENTION

In the following, only certain exemplary embodiments are briefly described. As one skilled in the art can recognize that the described embodiments may be modified in various different ways, without departing from the spirit and scope of the invention. Accordingly, the drawings and the description are to be regarded as illustrative rather than limiting.

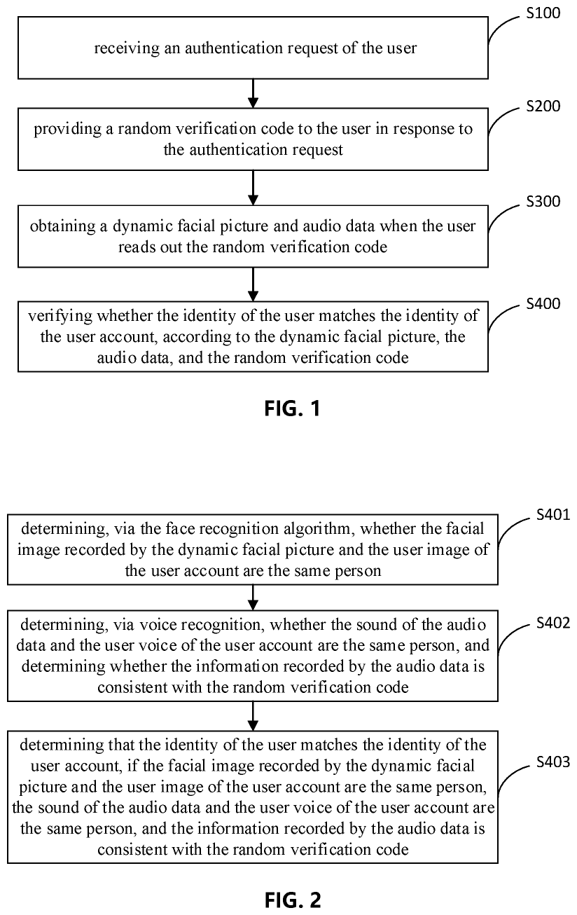

Referring to FIG. 1, an embodiment of the present invention provides a method for authentication, which can be applied to a server or a user terminal. User terminals include, but are not limited to, PC computers, smart phones, tablets, and the like. In this embodiment, if executed by the server, the user provides relevant information such as pictures or audio data to the server through the user terminal for the work of verification. The method provided in this embodiment includes step S100 to step S400, as follows:

S100, receiving an authentication request of the user; the authentication request includes a user account.

In this embodiment, when registering a new user, the user can define information such as the user name, the user account, and the like, and generally also sign the registration. During this process, enable the camera and microphone of the user terminal and enter relevant information. The user's face is photographed by the camera, and one or more facial images are obtained as the user image of the newly created user account. The user's voice is captured through the microphone as the user's voice for the new user account. The biometric data such as the user image and the user voice is stored in the database as signature information or identity information of the newly created user account.

S200, providing a random verification code to the user in response to the authentication request; wherein the random verification code is used to prompt the user to make a sound and read the verification code.

In this embodiment, the sound may be emitted through the speaker to provide a random verification code to the user, or the random verification code may be displayed on the screen for viewing by the user. The random verification code can be randomly generated, and the random verification code can include a combination of numbers, letters or words. For example, a random combination of numbers and letters: A939, B7L9, 02983KJA, etc.

S300, obtaining a dynamic facial picture and audio data when the user reads out the random verification code.

In this embodiment, the dynamic facial picture can prevent the unauthorized person from using the user's photo corresponding to the user account to deceive the device for authentication. The audio data contains the information of the random verification code, which can prevent the unauthorized person from using the voice record of the user corresponding to the user account to deceive the device for authentication.

S400, verifying whether the identity of the user matches the identity of the user account, according to the dynamic facial picture, the audio data, and the random verification code.

In the embodiment of the present invention, when verifying the identity of the user, a random verification code may be provided to the user, and the user may sound and read the verification code when learning the random verification code. The corresponding dynamic facial picture and audio data can be obtained during the process of reading the verification code, so that the unauthorized person can be prevented from using the photo of the authorized person or the audio record of the authorized person to obtain authorization during the process of verifying the identity of the user. It can improve the security of authentication.

In some possible implementations, in the implementation of the foregoing step S300, the method may include: obtaining images within the capture range through a camera; and then determining whether the obtained image is a dynamic facial picture when the random verification code is read out and when the obtained image is not a dynamic face picture when the random verification code is read, the user's authentication request is rejected.

In this embodiment, a corresponding face recognition algorithm can be generated through a series of AI training. The face recognition algorithm can determine whether the picture obtained by the shooting is obtained from a still photo or a photo stored by the electronic device or a dummy. And the camera acquires a plurality of pictures in the capture range, and the face recognition algorithm can determine whether the obtained picture is a dynamic facial picture when the random verification code is read by the change of the plurality of pictures.

In some possible implementation manners, as shown in FIG. 2, the foregoing step S400 may include steps S401 to S403, as follows:

S401, determining, via the face recognition algorithm, whether the facial image recorded by the dynamic facial picture and the user image of the user account are the same person.

S402, determining, via voice recognition, whether the sound of the audio data and the user voice of the user account are the same person, and determining whether the information recorded by the audio data is consistent with the random verification code.

S403, determining that the identity of the user matches the identity of the user account, if the facial image recorded by the dynamic facial picture and the user image of the user account are the same person, the sound of the audio data and the user voice of the user account are the same person, and the information recorded by the audio data is consistent with the random verification code.

In this embodiment, when the information recorded in the audio data is inconsistent with the random verification code, the authentication request of the user may be rejected. When the information recorded in the audio data is consistent with the random verification code, it indicates that the user can correctly read the random verification code to prove that the audio data is not an audio record recorded by the user in advance.

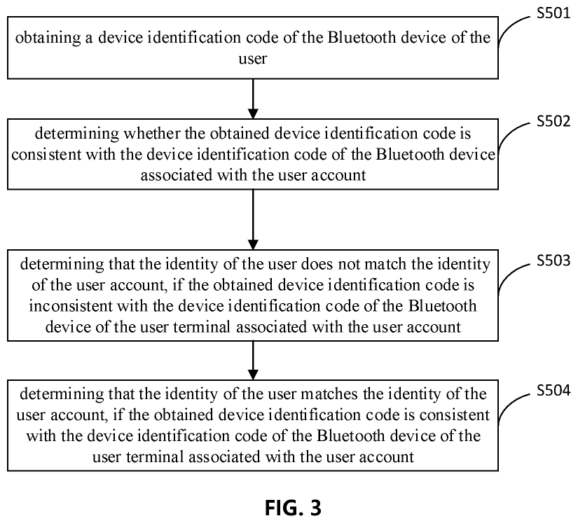

In some possible implementation manners, the embodiment may further allocate a Bluetooth device to the user when the user registers, and the Bluetooth device has a unique device identification code, which may further improve the security of the authentication. And Bluetooth devices can be set to anti-spoofing, which can prevent hackers or attackers from changing the information sent by Bluetooth devices. Therefore, as shown in FIG. 3, the embodiment of the present invention may further comprise:

S501, obtaining a device identification code of the Bluetooth device of the user;

S502, determining whether the obtained device identification code is consistent with the device identification code of the Bluetooth device associated with the user account;

S503, determining that the identity of the user does not match the identity of the user account, if the obtained device identification code is inconsistent with the device identification code of the Bluetooth device of the user terminal associated with the user account;

S504, determining that the identity of the user matches the identity of the user account, if the obtained device identification code is consistent with the device identification code of the Bluetooth device of the user terminal associated with the user account.

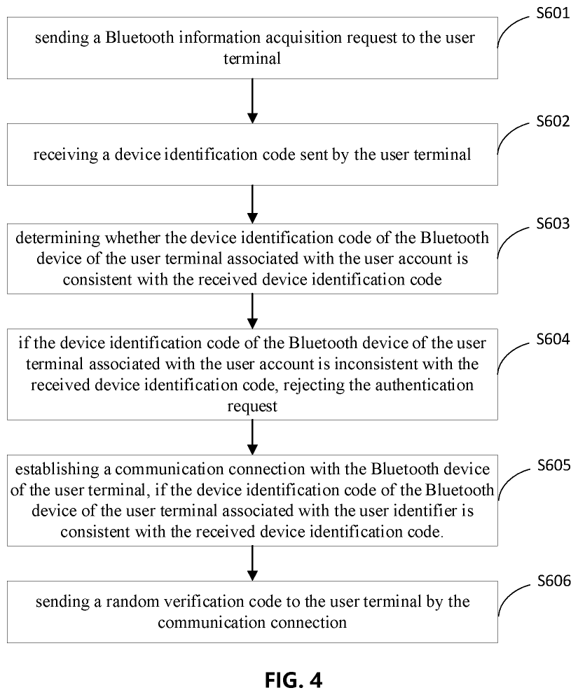

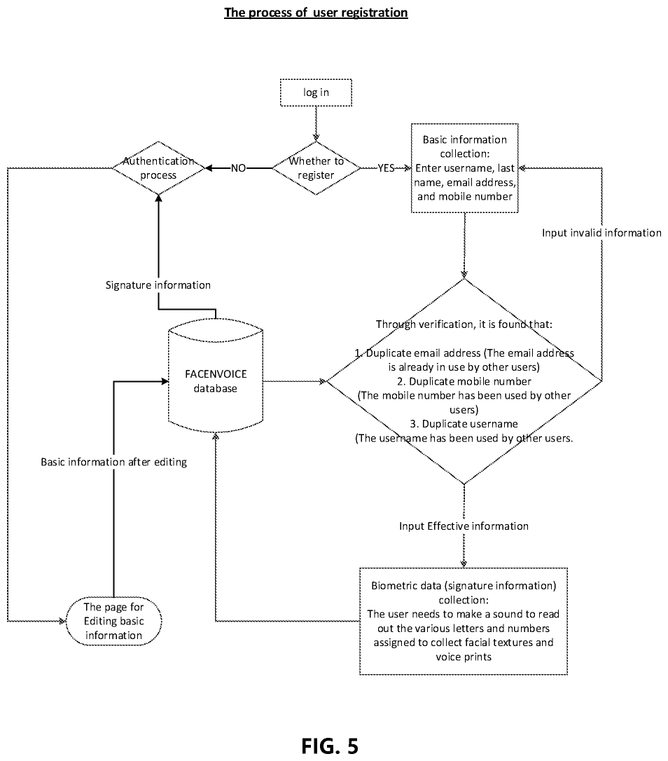

In some possible implementation manners, the embodiment may receive an authentication request of the user by using the user terminal. The user terminal generally includes a Bluetooth device, and each Bluetooth device has a unique device identification code, and the Bluetooth device can send its own device identification code for other Bluetooth signal receivers to detect and establish a communication connection. Therefore, as shown in FIG. 4, the method of the embodiment is applied to a server and interacts with the user terminal, and may comprise:

S601, sending a Bluetooth information acquisition request to the user terminal. The Bluetooth information acquisition request is configured to acquire a device identification code of the Bluetooth device of the user terminal.

S602, receiving a device identification code sent by the user terminal.

S603 determining whether the device identification code of the Bluetooth device of the user terminal associated with the user account is consistent with the received device identification code.

S604, if the device identification code of the Bluetooth device of the user terminal associated with the user account is inconsistent with the received device identification code, rejecting the authentication request.

In the embodiment of the present invention, when the user account is registered, the mobile phone number of the user corresponding to the user account or the device identification code of the Bluetooth device may be stored in association with the user account. The device identification code of the Bluetooth device is used to establish a communication connection with the Bluetooth device of the user terminal, and the random verification code is transmitted to the user terminal through the Bluetooth device, so that the user can use the random verification code for authentication. Therefore, as shown in FIG. 4, the method provided in this embodiment may further include:

S605, establishing a communication connection with the Bluetooth device of the user terminal, if the device identification code of the Bluetooth device of the user terminal associated with the user identifier is consistent with the received device identification code.

S606. sending a random verification code to the user terminal by the communication connection.

In some possible implementation manners, the method for authentication provided by this embodiment may be applied to the field of financial payment, for example, credit card payment. When the user wants to make an online payment, in addition to requiring the user to input a password to authenticate the user terminal, the user is required to perform the authentication of the embodiment to improve the security of the payment. Therefore, the method for authentication provided in this embodiment may further comprise: receiving a payment password of the user; determining whether the payment password of the user is consistent with the payment password bound to the user account; and performing the payment of the user, if the payment password of the user is consistent with the payment password bound to the user account, and the identity of the user matches the identity of the user account.

In some possible implementation manners, the method for authentication provided in this embodiment may further comprise: logging in the user account, if the identity of the user matches the identity of the user account. This embodiment can be applied to the field of system login to improve the security performance of login.

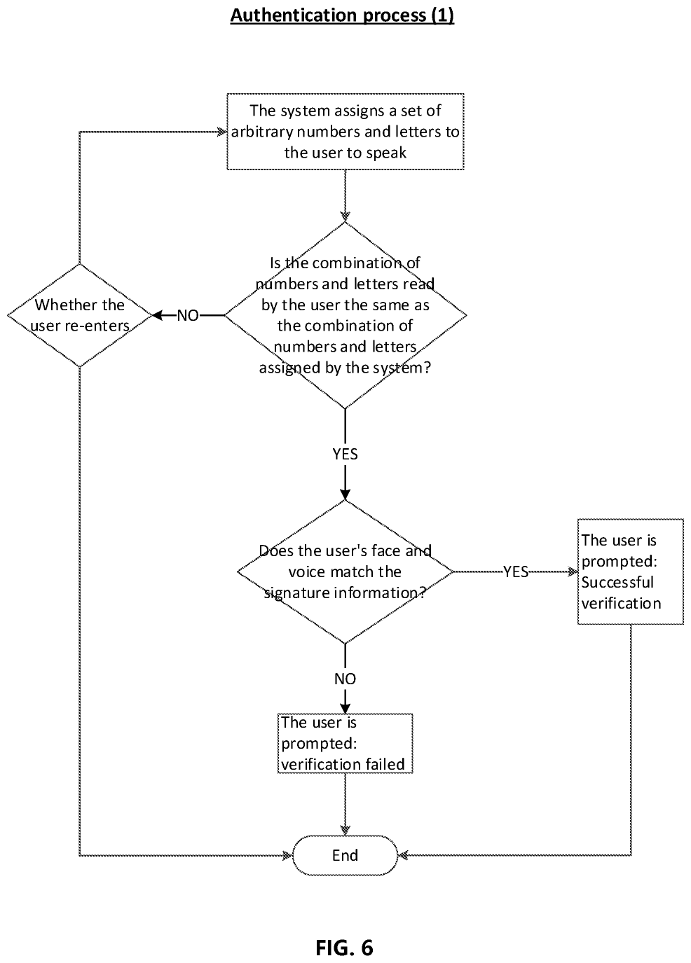

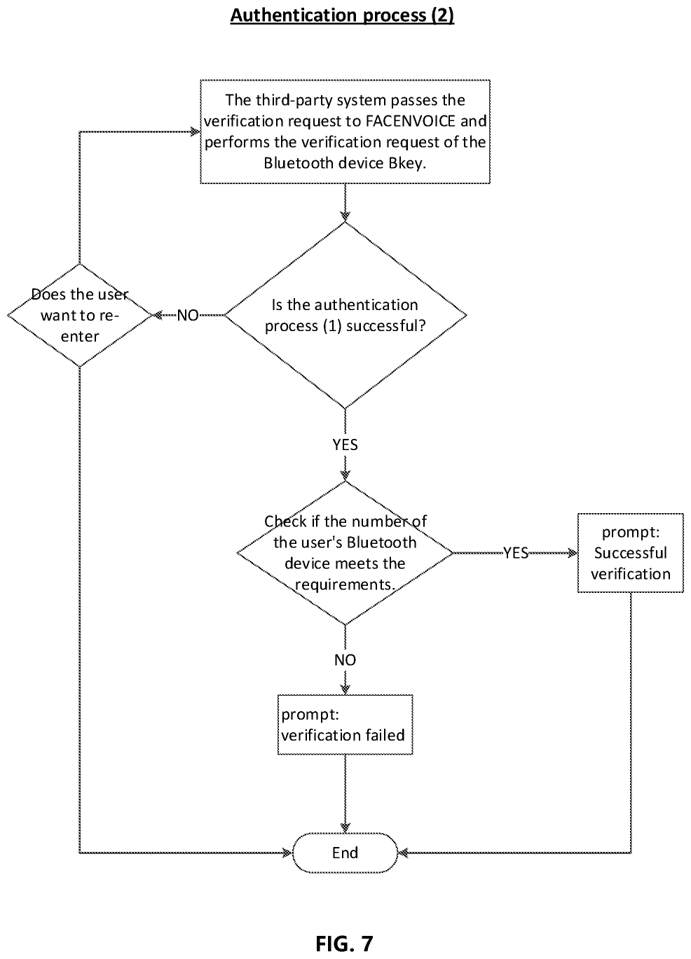

As shown in FIG. 5, FIG. 6, and FIG. 7, the embodiment of the present invention further provides a schematic diagram of an application example of a method for authentication. This embodiment is applied to the face and voice recognition system FACENVOICE. The face and voice recognition system FACENVOICE uses natural language processing methods such as face recognition algorithms and voice recognition algorithms to implement authentication. The key elements utilized by the face and voice recognition system FACENVOICE's authentication include: the registration with user account, verification without verifying the serial number of the Bluetooth device, verification with verifying the serial number of the Bluetooth device, and third party tools. The third party tool is provided to a third party developer, using an API and SDK of the OAuth protocol or the like to perform authentication using the face and voice recognition system FACENVOICE provided by the embodiment.

### 1. Registration With User Account

As shown in FIG. 5, the process of the registration is the process by which a new user defines an username and signature information for itself. After the user defines the basic information of the user, for example, the user name, the gender, the email address, and the mobile phone number, it will come into the process of Signature Registration (entry the signature information). This will require the user to enable the camera and microphone device, for example, to say some letters and numbers or phrases in front of the phone or PC. The following biometric data for this user will be collected into the database:

(1) User's face (multiple photos taken by “Signature Registration”)

(2) User's voice (audio record captured by “Signature Registration”)

These biometric data will be the user's signature information and stored in the database of the face and voice recognition system FACEVOICE.

### 2. Device Identification Code (Serial Number) of Bluetooth Device Bkey

Bkey is a Bluetooth device. Each BKey will have a unique Bkey device identification code, and Bkey itself can send the Bkey device identification code for detection by other Bluetooth signal receivers. The new user can be assigned a Bluetooth device when the user account is registered.

### 3. Verification Without Verifying the Serial Number of the Bluetooth Device

As shown in FIG. 6, it is the authentication process for the face and voice recognition system FACENVOICE. Authentication is the process of verifying whether the user is the user account for which he or she is logged in. Users need to enable cameras and microphone devices, for example, to authenticate in front of a mobile phone or PC.

A combination of numbers and letters, such as A939, B7L9, 02983KJA, etc., is displayed on the screen of the mobile phone or PC device. This combination of numbers and letters will be arbitrarily assigned by the face and voice recognition system FACENVOICE, or by a third party system via the API provided by the face and voice recognition system FACENVOICE.

To prevent hackers or attackers from using pre-prepared photos to spoof face recognition, or to use pre-recorded audio to spoof voice recognition, natural language processing algorithms are also deployed to correctly identify the user by making a sound to read any number and group of letters. Any combination of numbers and letters is generated at any time to prevent hackers or attackers from using pre-recorded audio recordings to pretend to be pre-defined content said by users corresponding to user accounts, such as social security numbers, date of birth, name of the pets, etc.

In the process of the user reading out the combination of the displayed numbers and letters, the face and voice recognition system FACENVOICE can determine whether the user in front of the screen of the device is the user of the logged-in user account by:

(1) Face recognition is performed using a photograph taken when the user reads a combination of the displayed numbers and letters in front of the camera of the user terminal. In the face recognition process, the system will further use the trained AI algorithm to determine if the face in the photo is just a pre-photographed photo or an image displayed on the electronic device. If such a photo or image is identified, the system will treat the face recognition process as a failure.

(2) When the user reads the displayed combination of numbers and letters in front of the microphone of the device, the captured audio data is used for voice recognition.

(3) When the user can correctly read out the combination of the displayed numbers and letters, it can be proved that the sound is not pre-recorded audio data.

### 4. Verification With Verifying the Serial Number of the Bluetooth Device

As shown in FIG. 7, in the process of the verification without verifying the serial number of the Bluetooth device, after the verification is successful, the Bluetooth device Bkey assigned to the user can be further verified to further improve the security of the verification. Bkey is a Bluetooth device, each Bluetooth device can send a unique electronic signal, such as Bkey's device identification code. Bkey has anti-spoofing function to prevent hackers or attackers from changing the electronic signals sent by Bkey.

The third party system uses the face and voice recognition system FACENVOICE to verify the identity of the user, and the third party system can send a verification request of the Bluetooth device Bkey to the face and voice recognition system FACENVOICE according to the verification request.

After the process of the verification without verifying the serial number of the Bluetooth device has been successfully verified, determining whether the electronic signal sent by the user's Bluetooth device is matched with the serial number of the Bluetooth device to which the user account is bound. If yes, the authentication is successful, if not, the authentication is failed.

### 5. Third Party Tools

The face and voice recognition system FACENVOICE is provided by third party developers, and API and SDK of the OAuth protocol or similar technology can be used to perform authentication using the face and voice recognition system FACENVOICE provided by this embodiment.

In this embodiment, OAuth 2.0 is an industry standard license agreement. OAuth 2.0is an agreement based on the work done by the original OAuth protocol created in 2006. OAuth 2.0 focuses on the simplicity of client developers while providing a specific authorization process for applications such as web applications and desktop applications.

Based on this, the following will describe financial payment as an example:

The face and voice recognition system FACENVOICE is deployed in the gateway of credit card payment as an authentication tool. For example, when a user makes an online payment, in addition to verifying the password or other information required by the gateway of credit card payment, the user also needs to successfully authenticate with the face and voice recognition system FACENVOICE to make online payment.

This embodiment can also be described by taking a multi-service software environment as an example:

The face and voice recognition system FACENVOICE is deployed in two software systems from different vendors, such as user terminals and servers. Therefore, after the user authenticates with the face and voice recognition system FACENVOICE in the user terminal, the user can continue to interact with the server using two software systems in the user terminal without having to log in to the server again.

As shown in FIG. 8, an embodiment of the present invention further provides an apparatus for authentication, including:

an authentication request receiving module 100, configured to receive an authentication request of the user; the authentication request includes a user account;

a verification code providing module 200, configured to provide a random verification code to the user in response to the authentication request, wherein the random verification code is used to prompt the user to make a sound and read the verification code; and

a picture and audio receiving module 300, configured to acquire a dynamic facial picture and audio data when the user reads the random verification code;

an authentication module 400, configured to verify whether the identity of the user matches the identity of the user account, according to the dynamic facial picture, the audio data, and the random verification code.

The functions of the device may be implemented by hardware or by corresponding software implemented by hardware. The hardware or software includes one or more modules corresponding to the functions described above.

In one possible design, the structure of the authentication includes a processor and a memory for storing a program of the method for authentication in the above first aspect performed by the authentication device, the processor being configured to execute the program stored in the memory. The device for authentication may also include a communication interface, the device for authentication communicating with other devices or communication networks.

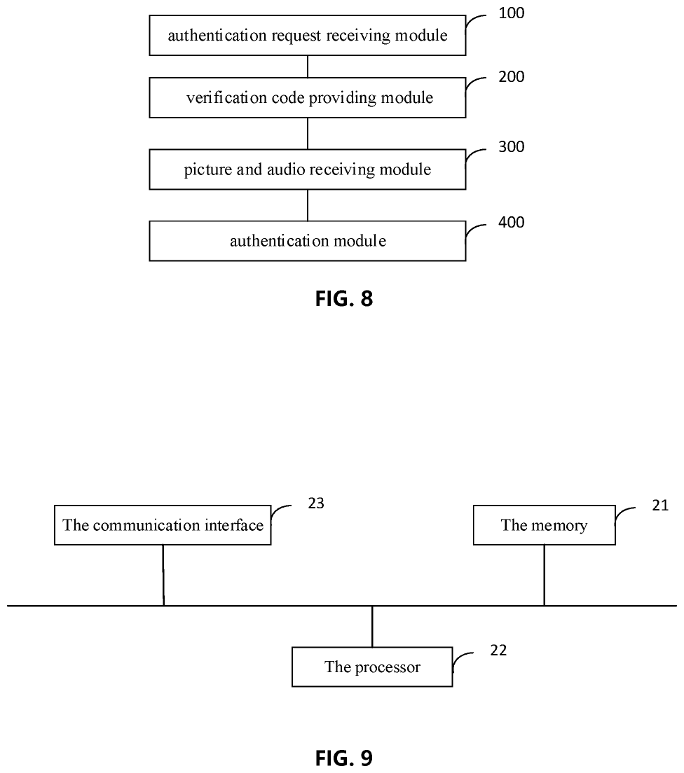

The embodiment of the present invention further provides a terminal device. As shown in FIG. 9, the device includes a memory 21 and a processor 22. The memory 21 stores a computer program executable on the processor 22. The processor 22 executes the computer program to perform the method of implementing the authentication as described in the above embodiments. The number of memories 21 and processors 22 may be one or more.

The device also includes:

The communication interface 23, configured to communicate between the processor 22 and an external device.

The memory 21 may include a high speed RAM memory and may also include a non-volatile memory such as at least one disk memory.

If the memory 21, the processor 22, and the communication interface 23 are independently implemented, the memory 21, the processor 22, and the communication interface 23 can be connected to each other through a bus and complete communication with each other. The bus may be an Industrial Standard Architecture (ISA) bus, a Peripheral Component (PCI) bus, or an Extended Industry Standard Component (EISA) bus. The bus can be divided into an address bus, a data bus, a control bus, and the like. For ease of representation, only one thick line is shown in FIG. 9, but it does not mean that there is only one bus or one type of bus.

Optionally, in a specific implementation, if the memory 21, the processor 22, and the communication interface 23 are integrated on one chip, the memory 21, the processor 22, and the communication interface 23 can complete communication with each other through the internal interface.

In the description of the present specification, the description with reference to the terms “one embodiment”, “some embodiments”, “example”, “specific example”, or “some examples” and the like means a specific feature described in connection with the embodiment or example. A structure, material or feature is included in at least one embodiment or example of the invention. Furthermore, the particular features, structures, materials, or characteristics described may be combined in a suitable manner in any one or more embodiments or examples. In addition, various embodiments or examples described in the specification, as well as features of various embodiments or examples, may be combined and combined.

Moreover, the terms “first” and “second” are used for descriptive purposes only and are not to be construed as indicating or implying a relative importance or implicitly indicating the number of technical features indicated. Thus, features defining “first” and “second” may include at least one of the features, either explicitly or implicitly. In the description of the present invention, the meaning of “a plurality” is two or more unless specifically and specifically defined otherwise.

Any process or method description in the flowcharts or otherwise described herein may be understood to represent a module, segment or portion of code that includes one or more executable instructions for implementing the steps of a particular logical function or process. And the scope of the preferred embodiments of the invention includes additional implementations, in which the functions may be performed in a substantially simultaneous manner or in an opposite order depending on the functions involved, in the order shown or discussed. It will be understood by those skilled in the art to which the embodiments of the present invention pertain.

The logic and/or steps represented in the flowchart or otherwise described herein, for example, may be considered as an ordered list of executable instructions for implementing logical functions, and may be embodied in any computer readable medium, Used in conjunction with, or in conjunction with, an instruction execution system, apparatus, or device (eg, a computer-based system, a system including a processor, or other system that can fetch instructions and execute instructions from an instruction execution system, apparatus, or device) Or use with equipment. For the purposes of this specification, a “computer-readable medium” can be any apparatus that can contain, store, communicate, propagate, or transport a program for use in an instruction execution system, apparatus, or device, or in conjunction with such an instruction execution system, apparatus, or device.

The computer readable medium of the embodiments of the present invention may be a computer readable signal medium or a computer readable storage medium or any combination of the two. More specific examples of computer readable storage media, at least (non-exhaustive list) include the following: electrical connections (electronic devices) having one or more wires, portable computer disk cartridges (magnetic devices), random access memory (RAM)), read only memory (ROM), erasable editable read only memory (EPROM or flash memory), fiber optic devices, and portable read only memory (CDROM). In addition, the computer readable storage medium may even be a paper or other suitable medium on which the program may be printed, as it may be optically scanned, for example by paper or other medium, followed by editing, interpretation or, if appropriate, in other suitable manners. Processing is performed to obtain the program electronically and then stored in computer memory.

In an embodiment of the invention, a computer readable signal medium may comprise a data signal propagating in a baseband or as part of a carrier, carrying computer readable program code. Such propagated data signals can take a variety of forms including, but not limited to, electromagnetic signals, optical signals, or any suitable combination of the foregoing. The computer readable signal medium can also be any computer readable medium other than a computer readable storage medium, which can transmit, propagate, or transport a program for use in or in connection with an instruction execution system, an input method, or a device. Program code embodied on a computer readable medium can be transmitted by any suitable medium, including but not limited to wireless, wire, optical cable, radio frequency (RF), and the like, or any suitable combination of the foregoing.

It should be understood that portions of the invention may be implemented in hardware, software, firmware or a combination thereof. In the above-described embodiments, multiple steps or methods may be implemented in software or firmware stored in a memory and executed by a suitable instruction execution system. For example, if implemented in hardware, as in another embodiment, it can be implemented by any one or combination of the following techniques well known in the art: having logic gates for implementing logic functions on data signals. Discrete logic circuits, application specific integrated circuits with suitable combinational logic gates, programmable gate arrays (PGAs), field programmable gate arrays (FPGAs), etc.

A person skilled in the art can understand that all or part of the steps carried by the method of the above embodiment can be completed by a program to instruct related hardware, and the program can be stored in a computer readable storage medium, including one or a combination of the steps of the method embodiments.

In addition, each functional unit in each embodiment of the present invention may be integrated into one processing module, or each unit may exist physically separately, or two or more units may be integrated into one module. The above integrated modules can be implemented in the form of hardware or in the form of software functional modules. An integrated module, if implemented in the form of a software functional module and sold or used as a standalone product, may also be stored in a computer readable storage medium. The storage medium may be a read only memory, a magnetic disk or an optical disk or the like.

The above is only the specific embodiment of the present invention, but the scope of the present invention is not limited thereto, and various changes or substitutions can be easily conceived by those skilled in the art within the technical scope of the present disclosure. These should be covered by the scope of the present invention. Therefore, the scope of protection of the present invention should be determined by the scope of the claims.

What is claimed is:

1. A method for authentication, comprising:
receiving an authentication request of the user; the authentication request includes a user account;
providing a random verification code to the user in response to the verification request;
wherein the random verification code is used to prompt the user to make a sound and read out the verification code;
obtaining a dynamic facial picture and audio data when the user reads the random verification code; and
verifying whether the identity of the user matches the identity of the user account, according to the dynamic facial picture, the audio data, and the random verification code.

2. The method according to claim 1, wherein the obtaining a dynamic facial image when the user reads the random verification code comprises:
obtaining images within the camera range through a camera;
determining whether the obtained image is a dynamic facial picture obtained when the random verification code is read out; and
rejecting the verification request of the user, if the obtained image is not a dynamic face picture obtained when the random verification code is read.

3. The method according to claim 1, wherein the verifying whether the identity of the user matches the identity of the user account, according to the dynamic facial picture, the audio data, and the random verification code, comprising:
determining, via the face recognition algorithm, whether the facial image recorded by the dynamic facial picture and the user image of the user account are the same person;
determining, via voice recognition, whether the sound of the audio data and the user voice of the user account are the same person, and determining whether the information recorded by the audio data is consistent with the random verification code;
determining that the identity of the user matches the identity of the user account, if the facial image recorded by the dynamic facial picture and the user image of the user account are the same person, the sound of the audio data and the user voice of the user account are the same person, and the information recorded by the audio data is consistent with the random verification code.

4. The method according to claim 1, wherein the method further comprises:
obtaining a device identification code of the Bluetooth device of the user;
determining whether the obtained device identification code is consistent with the device identification code of the Bluetooth device associated with the user account;
determining that the identity of the user does not match the identity of the user account, if the obtained device identification code is inconsistent with the device identification code of the Bluetooth device of the user terminal associated with the user account;
determining that the identity of the user matches the identity of the user account, if the obtained device identification code is consistent with the device identification code of the Bluetooth device of the user terminal associated with the user account.

5. The method according to claim 1, wherein the random verification code comprises a combination of one or more of words, numbers or letters.

6. The method according to claim 1, wherein the method further comprises:
receiving a payment password of the user;
determining whether the payment password of the user is consistent with the payment password bound to the user account;
performing the payment operation of the user, if the payment password of the user is consistent with the payment password bound to the user account, and the identity of the user matches the identity of the user account.

7. The method according to claim 1, wherein the method further comprises:
logging in the user account, if the identity of the user matches the identity of the user account.

8. An apparatus for authentication, comprising:
an authentication request receiving module, configured to receive an authentication request of the user; the authentication request includes a user account;
a verification code providing module, configured to provide a random verification code to the user in response to the authentication request; wherein the random verification code is used to prompt the user to make a sound and read the verification code;
a picture and audio receiving module, configured to acquire a dynamic facial picture and audio data when the user reads the random verification code; and
an authentication module, configured to verify whether the identity of the user matches the identity of the user account, according to the dynamic facial picture, the audio data, and the random verification code.

9. A terminal device for implementing authentication, comprising:
One or more processors;
a storage device, configured to store one or more programs;
the one or more processors are caused to implement the authentication of claim 1 when the one or more programs are executed by the one or more processors.

10. A computer readable and non-transitory storage medium storing a computer program, wherein the program is executed by a processor to implement the method of authentication according to claim 1.
